(19) United States
(12) Patent Application Publication
(10) Pub. No.: US 2026/0318602 A1
(43) Pub. Date: Oct. 15, 2026

(54) FRAME OR STRUCTURE FOR MANUFACTURING POROUS TRANSPORT LAYERS AND HEAT TREATMENT APPARATUS INCLUDING THE SAME

(71) Applicants: Hyundai Motor Company, Seoul (KR); Kia Corporation, Seoul (KR)

(72) Inventor: Young June Park, Seoul (KR)

(73) Assignees: Hyundai Motor Company, Seoul (KR); Kia Corporation, Seoul (KR)

(21) Appl. No.: 19/174,261

(22) Filed: Apr. 9, 2025

(51) Int. Cl. F27D 5/00; F27D 7/02

(52) U.S. Cl. CPC F27D 5/00; F27D 7/02

(57) ABSTRACT

A frame or structure for manufacturing titanium-based porous transport layers applied to a heat treatment apparatus minimizes contamination of receiving parts, loading parts, porous transport layer molding sheets, etc., and minimizes deviations in physical properties even if a plurality of porous transport layers is stacked and treated.

### FIELD OF THE PRESENT DISCLOSURE

The present disclosure relates to a frame or structure for manufacturing porous transport layers and a heat treatment apparatus including the same.

### DESCRIPTION OF RELATED ART

An anode in a polymer electrolyte membrane (PEM) water electrolysis system is subjected to harsh conditions, and a porous transport layer (PTL) formed of a titanium-based material instead of a carbon-based material is employed. This PTL is located between the anode and a separator and contributes to inducing water electrolysis and oxygen generation reaction.

During the manufacturing process of the PTL, various factors may cause mixing of impurities or quality deviations.

The above information disclosed in this Background section is only for enhancement of understanding of the background of the present disclosure and therefore it may contain information that does not form the prior art that is already known in this country to a person of ordinary skill in the art.

### BRIEF SUMMARY

Various aspects of the present disclosure are directed to providing a frame and structure that may be used semi-permanently, minimize a deviation in temperature applied to porous transport layers (PTLs), and minimize impurities in the PTLs.

The objects of the present disclosure are not limited to the above-mentioned objects. The objects of the present disclosure will become clearer from the following description, and may be realized by means and combinations thereof disclosed in the claims.

In one aspect, the present disclosure provides a frame for manufacturing porous transport layers employed as a frame for manufacturing titanium-based porous transport layers applied to a heat treatment apparatus, and including at least one receiving part including an entrance disposed such that the porous transport layer enters and exits the at least one receiving part through the entrance, walls closing the at least one receiving part excluding the entrance, and an opening/closing part configured to adjust opening and closing of the entrance, wherein a member forming the at least one receiving part, the walls, and the opening/closing part include at least one of molybdenum, tungsten or zirconium.

In an exemplary embodiment of the present disclosure, the frame may further include a path fluidically communicating with an inside of the at least one receiving part to generate a gas flow.

In another exemplary embodiment of the present disclosure, the walls may include an outlet fluidically communicating with the path.

In yet another exemplary embodiment of the present disclosure, a diameter of the outlet may be 3 mm to 10 mm.

In yet another exemplary embodiment of the present disclosure, the path may fluidically communicate with a predetermined gap between the entrance and the opening/closing part.

In still yet another exemplary embodiment of the present disclosure, the at least one receiving part may include a plurality of receiving parts aligned in one direction to be stacked, spaces in the plurality receiving parts may be formed by a plurality of receiving members aligned in one direction and the walls connected to side parts of the plurality of receiving members, respectively, the plurality of receiving parts may have a shape having a predetermined margin compared to a shape of the porous transport layers; and a height of the plurality receiving parts may be greater than a thickness of the porous transport layers by 0.5 mm to 1.0 mm.

In a further exemplary embodiment of the present disclosure, a thickness of the walls may be 0.5 mm to 2.0 mm.

In another further exemplary embodiment of the present disclosure, a minimum distance between an inner wall of the heat treatment apparatus and the frame may be equal to or greater than 70 cm.

In another aspect, the present disclosure provides a structure for manufacturing porous transport layers employed as a support for manufacturing titanium-based porous transport layers applied to a heat treatment apparatus, and including a plurality of loading parts disposed so that the porous transport layers are loaded thereon, supports supporting the plurality of loading parts to form a predetermined interval between the plurality of loading parts, and a capping part configured to close the plurality of loading parts to be spaced apart from the plurality of loading parts by a predetermined interval, wherein the plurality of loading parts, the supports, and the capping part include at least one of molybdenum or tungsten.

In an exemplary embodiment of the present disclosure, the capping part may include an outlet.

In another exemplary embodiment of the present disclosure, the capping part may include an inner space and have one surface configured to be open, and the capping part may accommodate the loading parts and the supports through the one surface, and then be closed such that a predetermined gap is provided between the capping part and a surface in contact with the capping part.

In yet another aspect, the present disclosure provides a heat treatment apparatus for manufacturing porous transport layers including the frame or the structure.

Other aspects and exemplary embodiments of the present disclosure are discussed infra.

The above and other features of the present disclosure are discussed infra.

### BRIEF DESCRIPTION OF THE DRAWINGS

The above and other features of the present disclosure will now be described of illustration only, and thus are not limitative of the present disclosure, and wherein:

FIG. 1 is a schematic view briefly illustrating a frame for manufacturing porous transport layers according to an exemplary embodiment of the present disclosure;

FIG. 2 is a schematic view briefly illustrating a structure for manufacturing porous transport layers according to another exemplary embodiment of the present disclosure;

FIG. 3 is a schematic cross-sectional view briefly illustrating the frame for manufacturing porous transport layers according to an exemplary embodiment of the present disclosure;

FIG. 4 is a schematic cross-sectional view briefly illustrating the structure for manufacturing porous transport layers according to another exemplary embodiment of the present disclosure; and

FIG. 5 is a schematic cross-sectional view briefly illustrating a structure according to Comparative Example.

It should be understood that the appended drawings are not necessarily to scale, presenting a somewhat simplified representation of various preferred features illustrative of the basic principles of the present disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the present disclosure. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

Herein, a comma “,” may be interpreted as “and” or “or” depending on the context, and if the elements listed through the comma end with “or”, the comma may be interpreted as “or”.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise. In addition, it will be understood that, if a numerical range is disclosed in the description, such a range includes all continuous values from a minimum value to a maximum value of the range, unless stated otherwise. Furthermore, if such a range refers to integers, the range includes all integers from a minimum integer to a maximum integer, unless stated otherwise.

### Frame 100 for Manufacturing Porous Transport Layers

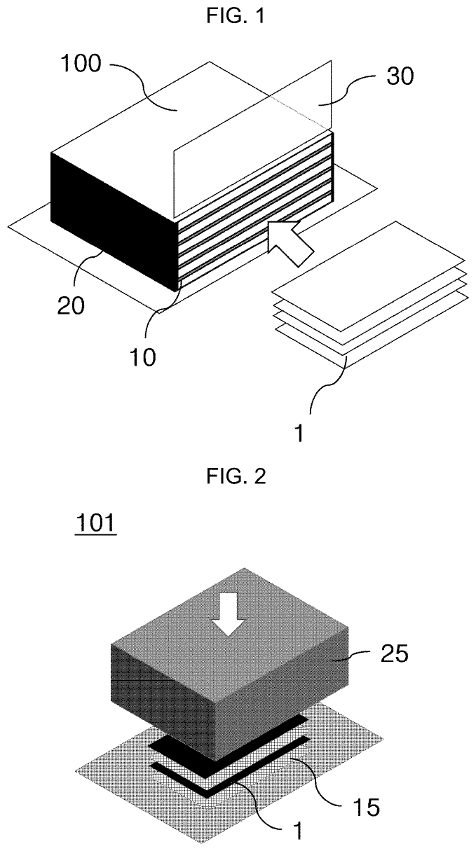

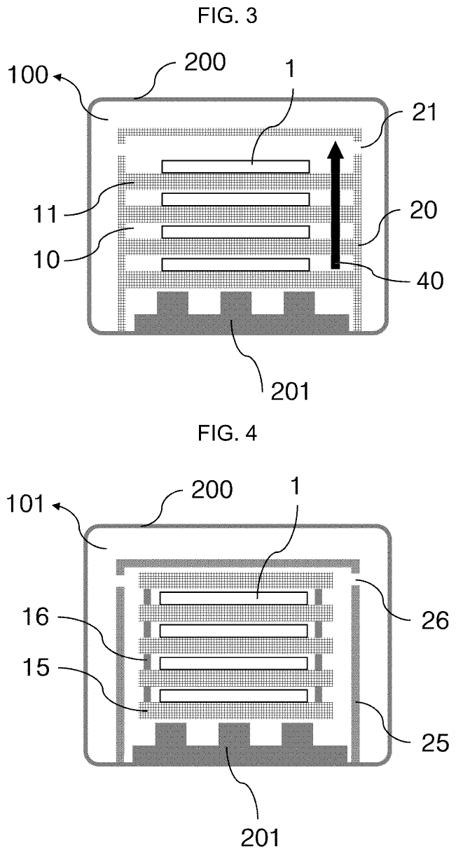

Referring to FIGS. 1 and 3, a frame 100 for manufacturing porous transport layers 1 according to an exemplary embodiment of the present disclosure is a frame 100 for manufacturing titanium-based porous transport layers 1 applied to a heat treatment apparatus 200, and may include at least one receiving part 10 including an entrance disposed such that the porous transport layer 1 enters and exits the at least one receiving part 10 through the entrance, walls 20 configured to close the at least one receiving part 10 excluding the entrance, and an opening/closing part 30 configured to adjust opening and closing of the entrance, and a member forming the at least one receiving part 10, the walls 20, and the opening/closing part 30 may include a material selected from the group consisting of molybdenum, tungsten, and a combination thereof.

The member that forms the receiving parts 10, the walls 20, and the opening/closing part 30 may include the same material, and for example, may include molybdenum or tungsten. In this case, contamination resistance of the porous transport layers 1 may be further improved.

The frame 100 may further include a path 40 that fluidically communicates with the insides of the receiving parts 10 and generates a gas flow.

A plurality of receiving parts 10 may be aligned in one direction to be stacked, as shown in FIG. 3, and spaces in the receiving parts 10 may be formed by a plurality of receiving members 11 stacked in one direction by a predetermined interval and the walls 20 connected to the side parts of the receiving members 11, respectively. If the receiving members 11 have a shape corresponding to the porous transport layers 1, i.e., a square shape, the walls 20 may be connected to be in contact with three sides of the receiving members 11.

Here, 2 to 50 receiving parts 10 may be provided, and the number of the receiving parts 10 may be changed depending on the inner space of the heat treatment apparatus 200.

The lower part of the receiving member 11 of the lowermost receiving part 10 among the plurality of receiving parts 10, i.e. the lower end of the frame 100 for manufacturing the porous transport layers 1, may define an open lower space that extends toward the walls 20, and a floor member 201 of the heat treatment apparatus 200 may be located in the lower space. The lower space may be closed so as to include only the floor member 201.

The receiving parts 10 may have a shape having a predetermined margin compared to the shape of the porous transport layers 1, and may have a height that is greater than the thickness of the porous transport layers 1 by 0.5 mm to 1.0 mm. With this height of the receiving parts 10, it may be possible to facilitate discharge of organic matter from a porous transport layer molding sheet, minimize internal contamination, and optimize space utilization.

The walls 20 may include an outlet 21 that fluidically communicates with the path 40.

The diameter of the outlet 21 may be 3 mm to 10 mm. With this diameter of the outlet 21, it may be possible to minimize inflow of contaminants into the receiving parts 10 and facilitate discharge of the organic matter that may be included in the porous transport layer molding sheet.

The thickness of the walls 20 may be 0.5 mm to 2.0 mm. With this thickness of the walls 20, it may be possible to prevent high temperature deformation and appearance deterioration of the porous transport layers 1 and enable continuous use of raw materials with minimal raw material costs.

As shown in FIG. 1, the opening/closing part 30 may open and close the entrances of the receiving parts 10, the walls 20 on one side and the other side of the entrances of the receiving parts 10 may include separate sliding rails, and both sides of the opening/closing part 30 move along the sliding rails to close entrances. Alternatively, the opening/closing part 30 and the walls 20 at the entrances are connected through a separate hinge.

When the entrances are closed by the opening/closing part 30 so as to perform heat treatment, a predetermined gap may exist between the opening/closing part 30 and the walls 20, and gas within the receiving parts 10 may be discharged without the separate outlet 21. The size of the gap may be 1 mm to 10 mm. With this size of the gap, it may be possible to minimize inflow of contaminants into the receiving parts 10 and facilitate discharge of the organic matter that may be included in the porous transport layer molding sheet.

Even if the opening/closing part 30 is located to close the entrances, the plurality of receiving parts 10 within the frame 100 may fluidically communicate with each other, the flow of gas may be guaranteed, and the path 40 through which the gas may move may be defined.

The path 40 may correspond to a predetermined gap between the entrances of the receiving parts 10 and the opening/closing part 30. The path 40 may fluidically communicate with the gap between the opening/closing part 30 and the walls 20 and/or the outlet 21.

In heat treatment and sintering operations, the inside of the frame 100 closed by the opening/closing part 30 may have a difference in a vacuum level with the outside, and accordingly, gas flow may occur between the path 40 and the outlet 21, between the path 40 and the gap between the opening/closing part 30 and the walls, etc.

The minimum distance from the inner wall of the heat treatment apparatus 200 to the frame 100 may be 70 cm or more but 140 cm or less. With this distance, it may be possible to prevent over-sintering and perform uniform heat treatment.

The minimum distance from the inner wall of the heat treatment apparatus 200 to the porous transport layer molding sheet in the receiving part 10 may be 100 cm or more but 170 cm or less. With this distance, it may be possible to prevent over-sintering and perform uniform heat treatment.

The plurality of receiving members 11, the walls 20, and opening/closing part related members of the frame 100 may be assembled through a punching unit, a fastening unit, a bonding unit, a welding unit, etc.

### Structure 101 for Manufacturing Porous Transport Layers

Referring to FIGS. 2 and 4, a structures 101 for manufacturing porous transport layers 1 according to another exemplary embodiment of the present disclosure is a structure 101 for manufacturing titanium-based porous transport layers 1 applied to a heat treatment apparatus 200, and may include a plurality of loading parts 15 provided such the porous transport layers 1 are loaded thereon, supports 16 configured to support the loading parts 15 so as to form a predetermined interval between the loading parts 15, and a capping part 25 configured to close the loading parts 15 so as to be spaced apart from the loading parts 15 by a predetermined interval, and the loading parts 15, the supports 16, and the capping part 25 may include a material selected from the group consisting of molybdenum, tungsten, and a combination thereof.

The loading parts 15, the supports 16, and the capping part 25 may include the same material, and for example, may include molybdenum or tungsten. In this case, contamination resistance of the porous transport layers 1 may be further improved.

The plurality of loading parts 15 may be aligned in one direction to be stacked, as shown in FIG. 4, and spaces on the loading parts 15 may be formed by the plurality of loading parts 15 and the supports 16 provided between the loading parts 15. If the loading parts 15 have a shape corresponding to the porous transport layers 1, i.e., a square shape, the supports 16 may be provided on one side and the other side of the loading parts 15.

Here, 2 to 50 loading parts 15 may be provided, and the number of the loading parts 15 may be changed depending on the inner space of the heat treatment apparatus 200.

The lower part of the lowermost loading part 15 among the plurality of loading parts 15, i.e. the lower end of the structure 101 for manufacturing the porous transport layers 1, may define an open lower space that extends toward the capping part 25, and a floor member 201 of the heat treatment apparatus 200 may be located in the lower space. The lower space may be closed so as to include only the floor member 201.

The interval between the loading parts 15 may be greater than the thickness of the porous transport layers 1 by 0.5 mm to 1.0 mm. With this intervals between the loading parts 15, it may be possible to facilitate discharge of organic matter from a porous transport layer molding sheet, minimize internal contamination, and optimize space utilization.

### The Capping Part 25 may Include a Separate Outlet 26.

The diameter of the outlet 26 may be 3 mm to 10 mm. With this diameter of the outlet 26, it may be possible to minimize inflow of contaminants into the loading parts 15 and facilitate discharge of the organic matter that may be included in the porous transport layer molding sheet.

The thickness of the capping part 25 may be 0.5 mm to 2.0 mm. With this thickness of the capping part 25, it may be possible to prevent high temperature deformation and appearance deterioration of the porous transport layers 1 and enable continuous use of raw materials with minimal raw material costs.

The capping part 25 may open or close the loading parts 15, and include an inner space formed by opening one surface of the capping part 25.

When closing the loading parts 15 by the capping part 25, the loading parts 15 may be located in the inner space of the capping part 25, and may be closed to come into contact with an area corresponding to the ground or an area corresponding to the bottom surface of the heat treatment apparatus 200.

When closing the loading parts 15 by the capping part 25 so as to perform heat treatment, a predetermined gap exists between the capping part 25 and an adjacent surface, i.e., the bottom surface of the heat treatment apparatus 200, and thus inner gas may be discharged without the separate outlet 26. The size of the gap can be 2 mm to 10 mm. With the size of the gap, it may be possible to minimize inflow of contaminants into the loading parts 15 and facilitate discharge of the organic matter that may be included in the porous transport layer molding sheet.

The inner surface of the capping part 25 may be spaced apart from the loading parts 15 by a designated interval, and include a path through which gas may move.

In heat treatment and sintering operations, the inside of the structure 101 closed by the capping part 25 may have a difference in a vacuum level with the outside, and accordingly, gas flow may occur between the path and the outlet 26, between the path and the gap, etc.

The minimum distance from the inner wall of the heat treatment apparatus 200 to the structure 101 may be 70 cm or more but 140 cm or less. With this distance, it may be possible to prevent over-sintering and perform uniform heat treatment.

The minimum distance from the inner wall of the heat treatment apparatus 200 to the porous transport layer molding sheet in the loading part 15 may be 100 cm or more but 170 cm or less. With this distance, it may be possible to prevent over-sintering and perform uniform heat treatment.

The plurality of loading parts 15, the supports 16, and capping part related members of the structure 101 may be assembled through a punching unit, a fastening unit, a bonding unit, a welding unit, etc., and, in the case of molybdenum, may also be manufactured through metal 3D printing.

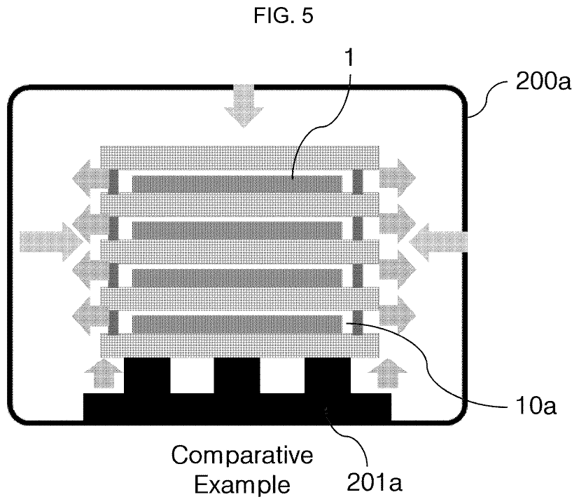

FIG. 5 shows a structure according to Comparative Example, including a refractory unit having a plurality of loading parts 10a on a floor member 201a within a heat treatment apparatus 200a and porous transport layer molding sheets 1 loaded on the loading parts 10a. When heat treatment and sintering were performed through the structure according to Comparative Example shown in FIG. 5, it was confirmed that organic matter included in the porous transport layer molding sheets 1 contaminated the entire area of the structure including the refractory unit, a carbon component of the floor member 201a was diffused into the inside of the loading parts 10a so that the impurity content of porous transport layers was somewhat higher than a reference and there was some deviations in physical properties.

When the frame 100 for manufacturing the porous transport layers 1 and the structure 101 for manufacturing the porous transport layers 1 according to an exemplary embodiment of the present disclosure were applied to heat treatment and sintering, due to use of molybdenum and/or tungsten and the unique structure of the frame 100 or the structure 101, it was confirmed that mixing of the component of the floor member 201 was prevented, the degree of contamination of the porous transport layers 1 by carbon and the degree of contamination of the porous transport layers 1 by other elements due to a binder were significantly low, and deviations of physical properties were minimized compared to Comparative Example. The heat treatment and sintering may correspond to degreasing and sintering operations which will be described below.

### Heat Treatment Apparatus 200 for Manufacturing Porous Transport Layers

Referring to FIG. 3 and FIG. 4, the heat treatment apparatus 200 for manufacturing the porous transport layers 1 according to an exemplary embodiment of the present disclosure may include the above-described frame 100 for manufacturing the porous transport layers 1 or structure 101 for manufacturing the porous transport layers 1.

The heat treatment apparatus 200 may include a conventional heating unit, and may include an electric furnace, a gas furnace, or the like.

The heat treatment apparatus 200 may include the floor member 201, and the frame 100 for manufacturing the porous transport layers 1 or the support 101 for manufacturing the porous transport layers 1 may be disposed on the floor member 201.

The minimum distance between the inner wall of the heat treatment apparatus 200 and the fame 100 or the structure 101 may be 70 cm or more but 140 cm or less. In addition, the minimum distance between the inner wall of the heat treatment apparatus 200 and the porous transport layer molding sheets disposed in the frame 100 or the structure 202 may be 100 cm or more but 170 cm or less. With these distances, it is possible to prevent over-sintering and perform uniform heat treatment.

The heat treatment 200 may include a pressurizer, a depressurizer, a vacuum pump, a gas inlet, a gas outlet, etc., and an inert gas may be injected or a vacuum level may be adjusted depending on a processing operation.

Heat treatment through the heat treatment apparatus 200 may include:
(a) disposing the porous transport layer molding sheets 1 in the receiving parts 10 of the frame 10 or on the loading parts 15 of the structure 101;
(b) removing a solvent and a binder from the porous transport layer molding sheets 1 by closing the receiving parts 10 with the opening/closing part 40 or closing the loading parts 15 with the capping part 25 and then performing the heat treatment; and
(c) sintering a result of operation (b).

The porous material transfer layer molding sheets 1 may include, for example, a metal for PTLs, a binder, a dispersant, a solvent, etc. The metal for PTLs may include titanium, nickel, stainless steel, etc. The binder may include polyvinyl butyral, polyvinyl alcohol, polyvinyl chloride, polyvinyl acetate, polyacrylonitrile, etc. The dispersant may include water, ethanol, methanol, isopropanol, xylene, cyclohexanone, acetone, methyl ethyl ketone, etc. The solvent may include an alcohol-based compound or a substituted/unsubstituted benzene-based compound.

The heat treatment temperature of operation (b) may be 300° C. to 700° C., and may be performed in an inert gas atmosphere or an argon gas atmosphere.

The sintering of operation (c) may be performed at a temperature of 900° C. to 1500° C., and under a vacuum level of 1×10⁻⁸ Torr to 1×10⁻⁵ Torr.

After operation (c), the furnace may be cooled together with maintaining the vacuum level.

As is apparent from the above description, a frame and structure for manufacturing porous transport layers according to an exemplary embodiment of the present disclosure may minimize contamination of receiving parts, loading parts, porous transport layer molding sheets, etc., and minimize deviations in physical properties even if a plurality of porous transport layers is stacked and treated.

The effects of the present disclosure are not limited to the above-mentioned effects. It should be understood that the effects of the present disclosure include all effect that may be inferred from the above description.

The present disclosure has been described in detail with reference to exemplary embodiments thereof. However, it will be appreciated by those skilled in the art that changes may be made in these embodiments without departing from the principles and spirit of the present disclosure, the scope of which is defined in the appended claims and their equivalents.

What is claimed is:

1. A frame for manufacturing porous transport layers employed as a frame for manufacturing titanium-based porous transport layers applied to a heat treatment apparatus, the frame comprising:
at least one receiving part comprising an entrance disposed so that a porous transport layer enters and exits the at least one receiving part through the entrance;
walls closing the at least one receiving part excluding the entrance; and
an opening/closing part configured to adjust opening and closing of the entrance,
wherein a member forming the at least one receiving part, the walls, and the opening/closing part comprise at least one of molybdenum, tungsten or zirconium.

2. The frame of claim 1, further comprising a path fluidically communicating with an inside of the at least one receiving part to generate a gas flow.

3. The frame of claim 2, wherein the walls comprise at least one outlet fluidically communicating with the path.

4. The frame of claim 3, wherein a diameter of the at least one outlet is 3 mm to 10 mm.

5. The frame of claim 2, wherein when the entrance is closed by the at least one opening/closing part to perform heat treatment, a predetermined gap exists between the at least one opening/closing part and the walls so that gas within the at least one receiving part is discharged through the predetermined gap.

6. The frame of claim 2, wherein the path fluidically communicates with a predetermined gap between the entrance and the at least one opening/closing part.

7. The frame of claim 1,
wherein the at least one receiving part comprises a plurality of receiving parts aligned in one direction to be stacked,
wherein spaces in the plurality receiving parts are formed by a plurality of receiving members aligned in the one direction and the walls connected to side parts of the plurality of receiving members, respectively,
wherein the plurality of receiving parts has a shape having a predetermined margin compared to a shape of the porous transport layers, and
wherein a height of each receiving part is greater than a thickness of each porous transport layer by 0.5 mm to 1.0 mm.

8. The frame of claim 1, wherein a thickness of the walls is 0.5 mm to 2.0 mm.

9. The frame of claim 1, wherein a minimum distance between an inner wall of the heat treatment apparatus and the frame is equal to or greater than 70 cm.

10. The frame of claim 1, wherein the at least one opening/closing part is slidably or hingedly coupled to the walls.

11. The frame of claim 1, wherein a minimum distance between the inner wall of the heat treatment apparatus and porous transport layer molding sheets disposed in the frame is 100 cm or more but 170 cm or less.

12. A structure for manufacturing porous transport layers employed as a support for manufacturing titanium-based porous transport layers applied to a heat treatment apparatus, the structure comprising:
a plurality of loading parts disposed so that the porous transport layers are loaded thereon;
supports supporting the plurality of loading parts to form a predetermined interval between the plurality of loading parts; and
a capping part including an inner space formed by opening one surface of the capping part and configured to open or close the plurality of loading parts which are spaced apart by a predetermined interval,
wherein the plurality of loading parts, the supports, and the capping part comprise at least one of molybdenum or tungsten.

13. The structure of claim 12, wherein the capping part comprises at least one outlet.

14. The structure of claim 12,
wherein the capping part accommodates the loading parts and the supports through the one surface, and is then closed such that a predetermined gap is disposed between the capping part and a surface of the heat treatment apparatus in contact with the capping part.

15. The structure of claim 12, wherein the predetermined gap is 2 mm to 10 mm.

16. The structure of claim 12, wherein a minimum distance between an inner wall of the heat treatment apparatus and the structure is equal to or greater than 70 cm.

17. The structure of claim 12, wherein a minimum distance between the inner wall of the heat treatment apparatus and porous transport layer molding sheets disposed in the structure is 100 cm or more but 170 cm or less.

18. The structure of claim 12, wherein a thickness of the capping part is 0.5 mm to 2.0 mm.

19. A heat treatment apparatus for manufacturing the porous transport layers comprising the frame of claim 1.
